(19) United States
(12) Patent Application Publication
(10) Pub. No.: US 2002/0088315 A1
(43) Pub. Date: Jul. 11, 2002

(54) Rotating tool for installing a threaded rebar coupler

(76) Inventors: David E. Thurman, St. Charles, MO (US); Brian P. Klein, St. Louis, MO (US)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 09/681,107

(22) Filed: Jan. 9, 2001

(51) Int. Cl. B25B 13/56

(52) U.S. Cl. 81/176.15

(57) ABSTRACT

A tool for engaging and rotating an end plate of a threaded rebar coupler for installing a coupler on an end section of rebar. The tool comprises a member and a shaft attachable to the member. The shaft may be received in a rotary drill for mechanized rotation of the shaft and member about an axis of the shaft. The member includes a plurality of extensions for engaging an end plate of the threaded rebar coupler to induce rotation of the threaded rebar coupler for threading the rebar coupler onto an end section of rebar. The tool is adapted for use on a variety of differently sized couplers.

### BACKGROUND OF THE INVENTION

This invention generally relates to rotating tools and more particularly to a rotating tool engageable with a threaded rebar coupler for rotating and threading the rebar coupler onto an end section of rebar.

Conventionally, steel rebar is used as a reenforcing member in concrete structures, adding strength to the concrete structure. Moreover, a frame of rebar formed within a body of concrete may take on many configurations, forming variously shaped concrete structures. Steel reenforced concrete, typically incorporating rebar within the concrete structure, is typically used to build roads and buildings because of its relatively low cost, ease of formation, strength and durability.

It is often important for items to attach directly to the rebar members of a steel reenforced concrete structure. These connections may facilitate attachment of other rebar or of various other items associated with the concrete structure. Threaded rebar couplers typically provide such an attachment mechanism. Couplers generally include a hollow cylinder with internal threads mounted perpendicular to an end plate. The coupler attaches to an end section of rebar by placing an open end of the hollow cylinder onto the rebar and rotating the coupler so that the threads engage the rebar and draw the coupler onto the rebar. The end section of rebar is often externally threaded to mate with the threaded cylinder.

The end plate may then be attached to an item outside the concrete structure (e.g., another concrete structure), or for some couplers a second portion of rebar may be inserted into another open end of the rebar coupler nearest the end plate.

Presently, rebar couplers are rotated manually for attachment to a section of rebar. This manual operation is both time-consuming and difficult. Additionally, installing many of these couplers can lead to user fatigue and over-use injuries. As such, a tool which would allow for mechanized installation of such a coupler is needed.

### SUMMARY OF INVENTION

Among the several objects and features of the present invention may be noted the provision of a tool that permits installation of a threaded rebar coupler with a rotary tool rather than manually; the provision of a tool that is adapted for rapid installation of rebar couplers; the provision of a tool that is readily adapted to engage a number of differently sized and/or configured couplers; and the provision of a tool that is simple to use.

According to one embodiment, a tool is disclosed for engaging and rotating a rebar coupler. The tool comprises a member having at least one extension engageable with an end plate of a threaded rebar coupler. The tool also comprises a shaft attached to the member, such that the shaft and member are rotatable about an axis of the shaft to engage a threaded rebar coupler via said at least one extension. The rotation of the tool induces rotation of the threaded rebar coupler for threading the rebar coupler onto an end section of rebar.

In a second embodiment of the present invention, a tool is disclosed for engaging and rotating a plate The tool comprises a member having at least one extension engageable with a plate. The tool also comprises a shaft, attached to the member, such that the shaft and member may be rotated about an axis of the shaft to engage the plate via said at least one extension for inducing rotation of the plate.

The present invention also comprises a method of threading a threaded rebar coupler onto an end section of rebar. The method comprises the steps of securing a tool in a rotating machine, such as a rotary drill. The method next requires engaging the tool with a threaded rebar coupler and engaging the threaded rebar coupler with an end section of rebar. Next, the drill is rotated to induce conjoint rotation of the tool and the coupler so that the threads of the coupler engage the rebar for mounting the coupler on the rebar.

Other objects and features will be in part apparent and in part pointed out hereinafter.

### BRIEF DESCRIPTION OF DRAWINGS

FIG. 1 is an exploded perspective of a rebar coupler and a tool of the present invention;

FIG. 2 is a section of the tool and rebar coupler taken in a plane including line 2-2 of FIG. 1

FIG. 3 is an exploded perspective of a rebar coupler and the tool of the present invention with detachable extensions;

FIG. 4 is a section of the tool and rebar coupler taken in a plane including line 4-4 of FIG. 3; and

FIG. 5 is a perspective of a tool of the present invention having another configuration.

Corresponding reference characters indicate corresponding parts throughout the several views of the drawings.

### DETAILED DESCRIPTION

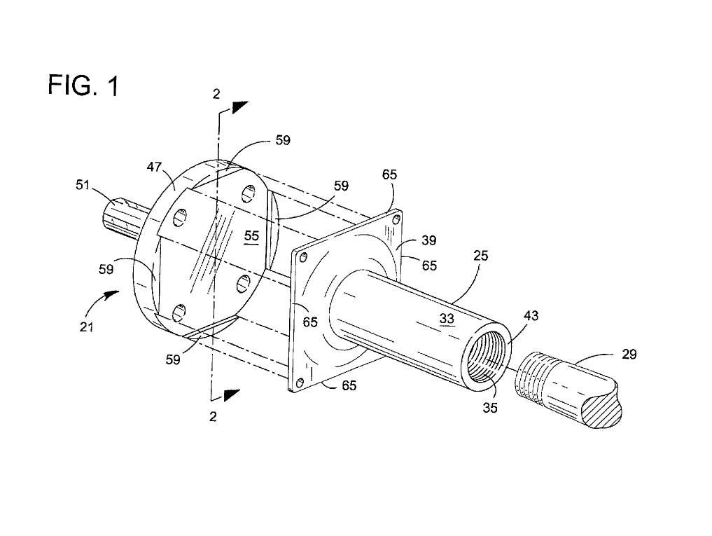

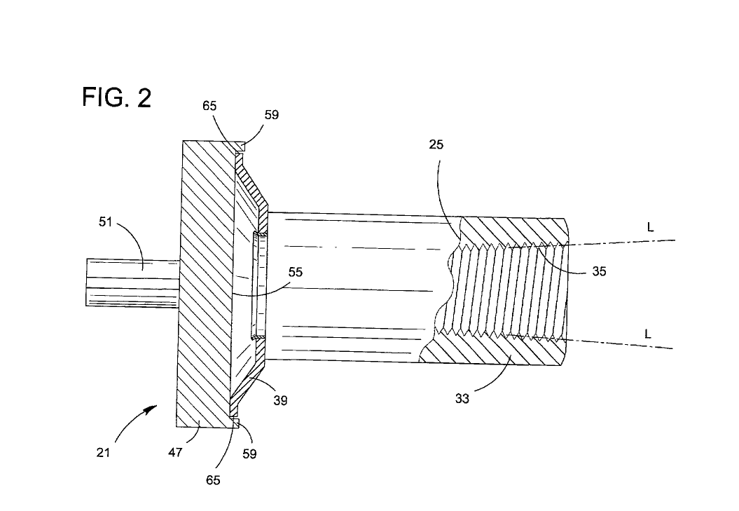

Referring now to the drawings and specifically to FIG. 1, a tool of the present invention, generally indicated by 21, is shown in exploded perspective with a threaded rebar coupler 25 and an end section of rebar 29. Threaded rebar couplers 25 are conventionally threaded onto threaded end sections of rebar 29 to facilitate attachment of the rebar to other items (not shown). Couplers 25 generally include a hollow cylinder 33 with internal threads 35 mounted to an end plate 39. The coupler 25 attaches to an end section of rebar 29 by placing an open end 43 of the coupler onto the rebar and rotating the coupler so that the threads 35 engage the threaded rebar and draw the coupler onto the rebar. The pitch line L (FIG. 2) of the interior threads 35 of the coupler 25 taper inwardly toward the midpoint of the cylinder 33 so that as the coupler threads onto the rebar 29, the cylinder opening decreases in diameter so that the cylinder fits more snugly on the rebar.

Conventionally, couplers 25 are rotated manually (such as by hand, with a wrench, etc.) for seating on an end section of rebar 29. The present tool 21 is adapted to engage the rebar coupler 25 for conjoint, mechanized rotation of the tool and coupler to increase the speed and efficiency of installation. The tool 21 generally comprises a member 47 and a shaft 51. The member 47 includes a face 55 and a plurality of extensions 59 engageable with the end plate 39 of the threaded rebar coupler 25. The extensions 59 extend generally perpendicularly outwardly from the face 55, near the lateral edges of the face, for engagement with a plurality of lateral edges 65 of the end plate 39 of the threaded rebar coupler 25. The member 47 is preferably circular in shape and the extensions 59 are chord-shaped continuations of the circular member. The chord-shaped extensions 59 and face 55 cooperate to form a seat that closely conforms to the outline of the end plate 39 for engaging the end plate. In the preferred embodiment, the member 47 and shaft 51 are of unitary construction, although they may also be formed separately and joined, with fasteners or by welding. The shaft 51 and member 47 are preferably formed from steel, although other materials capable of performing the tasks described herein (e.g., stainless steel, titanium, carbon fiber, polymers, etc.) are also contemplated as within the scope of the present invention.

The shaft 51 is preferably adapted for mounting within a rotary drill, so that the shaft and member 47 may be rotated about a canter axis of the shaft. The shaft 51 and member 47 are arranged so that the face 55 is oriented perpendicular to the shaft and adapted for flatwise engagement with the end plate 39 of the threaded rebar coupler 25. The close fit between the face 55 and extensions 59 and the end plate 39 facilitates conjoint rotation of the tool 21 and coupler 25 without relative movement between the tool and coupler. As the tool 21 rotates, the extensions 59 exert force upon the lateral edges 65 of the end plate 39, inducing rotation of the coupler 25. This allows for mechanized rotation of the coupler 25 for ease and speed in installation.

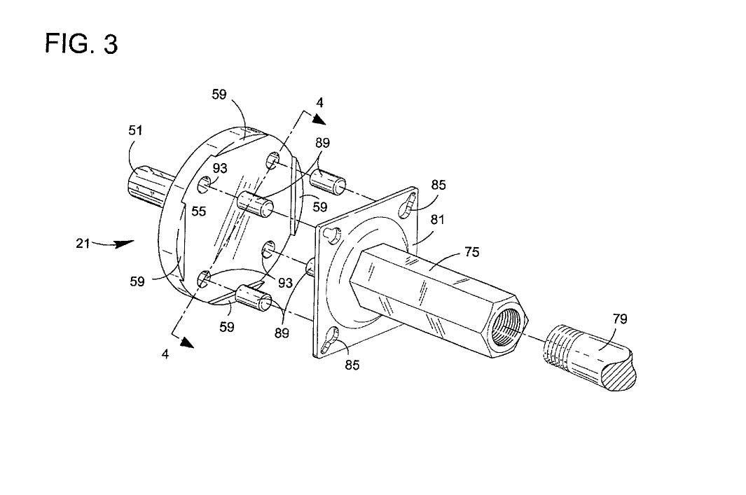

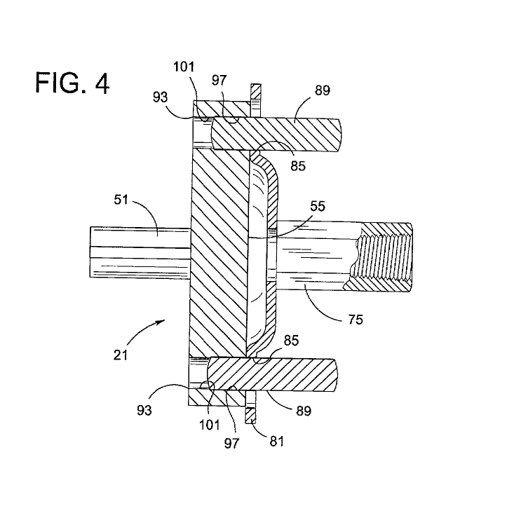

Referring now to FIGS. 3 and 4, the tool 21 is preferably adapted to engage differently sized rebar couplers. The rebar coupler 75 shown in FIG. 3 is adapted to thread onto smaller diameter rebar 79 and the end plate 81 of the coupler is correspondingly smaller. In addition, the end plate 81 includes four openings 85. These openings 85 allow the coupler 75 to attach to other items, such as concrete forms or structural members. The openings 85 also provide ready engagement points for the tool 21 of the present invention. The tool 21 of FIGS. 3 and 4 includes the face 55, shaft 51 and fixed extensions 59 described previously. Additionally, however, the tool 21 includes a plurality of attachable and detachable extensions 89. These extensions are cylindrically shaped and each snugly fit within a corresponding hole 93 in the face 55 of the tool 21. The extensions 89 are held within their respective holes 93 by friction. The attachable and detachable extensions 89 are engageable with the smaller rebar coupler 75 shown in FIGS. 3 and 4. The holes 93 each receive a detachable extension 89 within an first portion 97 of the hole 93. A second portion 101 of each hole 93 has a diameter smaller than the first portion 97 so that only part of each extension 89 may be inserted into each hole 93. The part of each extension 89 extending outward from each hole 93 and from the face 55 is engageable with a corresponding opening 85 in the end plate 81 of the coupler 75. As with the previous configuration, rotating the tool 21 with a rotary drill induces rotation of the coupler 75 for threading the rebar coupler onto a threaded end section of rebar 79 for more efficient installation of the coupler. The attachable and detachable extensions 89 transmit the rotational motion of the tool 21 to the coupler 75. With the extensions 89, the tool 21 may be used to install the smaller coupler 75. With the extensions 89 removed, the tool 21 may be used to install the larger coupler 25 (FIGS. 1 and 2). As should be apparent, the dimensions of the tool 21 may be selected to accommodate a variety of coupler sizes and configurations.

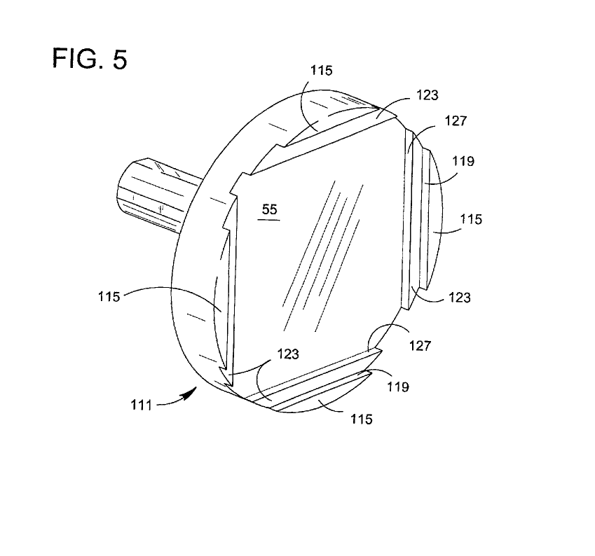

Referring to FIG. 5, an additional tool 111 is shown. The tool 111 includes extensions 115 having multiple first bearing surfaces 119 for engaging a rebar coupler 25 of the type shown in FIGS. 1 and 2. The first bearing surfaces 119 engage the lateral edges 65 of the end plate 39 so that rotation of the tool 111 induces conjoint rotation of the rebar coupler 25. In this configuration, the end plate 39 does not engage the tool face 55, but rather engages multiple pressure surfaces 123. Flatwise engagement of the end plate 39 on these pressure surfaces 123 helps align the end plate with the tool 111 for conjoint rotation. Moreover, the tool shown in FIG. 5 can engage the smaller rebar coupler 75 (shown in FIGS. 3 and 4) without additional attachable and detachable extensions. Rather, the end plate 81 of the smaller coupler 75 engages multiple second bearing surfaces 127 and the face 55 of the tool 111 for conjoint rotation of the tool and the coupler 75. As such, the tool 111 may engage and rotate differently sized rebar couplers 25,75 without modifying the configuration of the tool. It is contemplated that the tool of the present invention could be easily modified to accommodate additional rebar couplers having differently sized end plates by adding additional sets of bearing surfaces and pressure surfaces.

The tool may also be adapted to engage differently sized and shaped end plates not shown here, and other items having end plates, unrelated to rebar couplers. For instance, the tool could be adapted to engage any item having an end plate and requiring rotation of the item about an axis passing through the end plate. Moreover, tools formed to engage differently shaped rebar couplers (e.g., those not having an end plate) are also contemplated as within the scope of the present invention.

Preferably, the tool of the present invention is expected to engage a threaded coupler with a threaded end section of rebar. It is also contemplated that the tool of the present invention may be used to engage a heated section of unthreaded rebar with a coupler and rotate the coupler to create a friction weld between the unthreaded rebar and the coupler.

In view of the above, it will be seen that the several objects of the invention are achieved and other advantageous results attained.

When introducing elements of the present invention or the preferred embodiment(s) thereof, the articles “A”, “an”, “the” and “said” are intended to mean that there are one or more of the elements. The terms “comprising”, “including” and “having” are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense.

1. A tool for engaging and rotating a rebar coupler, said tool comprising:
a member having at least one extension engageable with an end plate of a threaded rebar coupler; and
a shaft attached to the member, such that the shaft and the member are rotatable about an axis of the shaft to engage a threaded rebar coupler via said at least one extension and induce rotation of the threaded rebar coupler for threading the rebar coupler onto an end section of rebar.

2. A tool as set forth in claim 1 further comprising a plurality of extensions.

3. A tool as set forth in claim 2 wherein the member further comprises a face perpendicular to the shaft and adapted for flatwise engagement with the end plate of the threaded rebar coupler.

4. A tool as set forth in claim 3 wherein the extensions extend generally perpendicularly from the face for engagement with the end plate of the threaded rebar coupler.

5. A tool as set forth in claim 4 wherein the tool is adaptable to engage differently sized rebar couplers.

6. A tool as set forth in claim 4 wherein the extensions extend outwardly from the face near the lateral edges of the face.

7. A tool as set forth in claim 6 wherein the extensions are adapted for engagement with a plurality of lateral edges of the end plate.

8. A tool as set forth in claim 7 wherein the member is circular and the extensions are chord-shaped continuations of the circular member.

9. A tool as set forth in claim 8 wherein said chord-shaped extensions and the face cooperate to form a seat that closely conforms to the outline of the end plate for engaging the end plate to facilitate conjoint rotation of the tool and coupler.

10. A tool as set forth in claim 5 wherein the extensions each comprise at least two sets of bearing surfaces for engagement of differently sized rebar couplers.

11. A tool as set forth in claim 10 wherein the member is circular and the extensions are chord-shaped continuations of the circular member, said extensions comprising multiple bearing surfaces for engaging and rotating differently sized rebar couplers without modifying the configuration of the tool.

12. A tool as set forth in claim 4 wherein at least one of the extensions are attachable to and detachable from the face.

13. A tool as set forth in claim 12 wherein the face further comprises at least one hole for receiving said at least one extension.

14. A tool as set forth in claim 13 wherein said at least one hole and said at least one extension are cylindrically shaped.

15. A tool for engaging and rotating a plate, said tool comprising:
a member having at least one extension engageable with a plate; and
a shaft attached to the member, such that the shaft and member may be rotated about an axis of the shaft to engage the plate via said at least one extension and induce rotation of the plate.

16. A tool as set forth in claim 15 further comprising a plurality of extensions.

17. A tool as set forth in claim 16 wherein the member further comprises a face perpendicular to the shaft and adapted for flatwise engagement with the plate for aligning the plate with the member.

18. A tool as set forth in claim 17 wherein the extensions extend generally perpendicularly from the face for engagement with the plate for rotation of the plate.

19. A tool as set forth in claim 18 wherein the tool is adaptable to engage differently sized plates.

20. A method of threading a threaded rebar coupler onto an end section of rebar comprising the steps of:
securing a tool in a rotating machine, such as a rotary drill;
engaging the tool with a threaded rebar coupler;
engaging the threaded rebar coupler with an end section of rebar; and
rotating the drill to induce conjoint rotation of the tool and the coupler so that the threads of the coupler engage the rebar for mounting the coupler on the rebar.
